(19) United States
(12) Patent Application Publication
(10) Pub. No.: US 2013/0146546 A1
(43) Pub. Date: Jun. 13, 2013

(54) Emergency Filtering and Oil Containment, Especially in Deepwater

(71) Applicant: Mary Elizabeth Goulet, McLean, VA (US)

(72) Inventor: Mary Elizabeth Goulet, McLean, VA (US)

(21) Appl. No.: 13/761,877

(22) Filed: Feb. 7, 2013

Related U.S. Application Data
(63) Continuation-in-part of application No. 13/168,082, filed on Jun. 24, 2011.
Application No. 13/168,082 is a continuation-in-part of application No. 13/050,292, filed on Mar. 17, 2011.
Application No. 13/050,292 is a continuation-in-part of application No. 12/845,839, filed on Jul. 29, 2010.
(60) Provisional application No. 61/350,001, filed on May 31, 2010.

(51) Int. Cl. C02F 1/40; E02B 15/06

(52) U.S. Cl. CPC C02F 1/40; E02B 15/06
USPC 210/747.5; 210/170.11; 405/60

(57) ABSTRACT

An emergency filtration response method to an underwater oil emergency, useable in deepwater.

### FIELD OF THE INVENTION

The invention relates to response to underwater oil flow especially emergency mitigation of oil emergencies in deepwater.

### BACKGROUND OF THE INVENTION

In April 2010, a BP oil drilling operation suffered a disaster resulting in a major underwater oil discharge. Weeks and even months later, the deepwater oil discharge was still ongoing. Large quantities of oil escaped from the vicinity of the disaster site coordinates and traveled to various places. Escaped oil was in plain view many miles away from the drilling operation coordinates, in water and coastal areas and on wildlife.

Over the next few months, various operations were attempted which involved forcing a heavy, solid-metal structure directly onto the broken equipment directly where the high-pressure oil was being discharged. After several tries, one of the custom-made heavy, solid-metal structures was fitted successfully onto the broken equipment.

The problem remains, however, in the event of another deepwater oil emergency with oil gushing at high-pressure, of needing a containment product that is ready for quick use. It would be wanted to avoid needing to wait while a heavy, metal structure is custom-built and deployed. What is wanted is to have an off-the-shelf containment product that is ready for immediate use and easily and quickly deployed to contain a high-pressure oil emergency especially in deepwater. However, as the containment operations in spring and summer 2010 showed, containing a high-pressure oil emergency in deep water is a difficult problem.

Marine Well Containment Company, formed after the BP Gulf problem and led by ExxonMobil in partnership with Chevron, ConocoPhillips and Shell, in a Feb. 17, 2011 press release described its solution under development as including a subsea capping stack. The subsea capping stack is illustrated on its website in its Interim Containment System (as well as in its Expanded Containment System) and is a large, heavy mechanical structure that sits directly atop a failed structure that is itself about five stories tall. Although Marine Well Containment Company indicates that in the event of an incident, deployment would begin within 24 hours, given the mass and size of its subsea capping stack, at least several days probably would be needed to get the subsea capping stack from its storage location to the surface above the emergency site and then to lower the solid-metal capping stack into position. In event of a situation in which there is no top part of a failed structure to receive Marine Well Containment Company's capping stack, another solution would seem to be needed. Even in situations where the Marine Well Containment capping stack can be successfully installed, a quick-response interim solution in the meantime would be useful.

### SUMMARY OF THE INVENTION

The invention solves the problem of containing an underwater oil discharge, particularly by using a relatively-flexible oil-impermeable, water-permeable material (such as, e.g., a fabric, an uncoated nylon material, etc.) to contain the oil discharge at its source, i.e., at approximately the longitudinal and latitude coordinates and underwater depth where the oil is spewing into the water. Tenting-over the high-pressure oil discharge at the seabed is accomplished using the oil-impermeable, water-permeable material, without the material directly contacting the oil stream where the stream is at highest pressure and instead disposing the material far-enough away that the pressure from the oil is not too high-pressure for the water-permeable material to physically tolerate. An inventive off-the-shelf oil containment product is useable for tenting-over a deepwater, high-pressure oil emergency, and advantageously, when a deepwater oil emergency occurs, such an off-the-shelf, relatively light-weight containment product can be transported immediately to the surface coordinates above the emergency, and deployed rapidly by emergency responders who have been able to previously practice using the containment product.

In one preferred embodiment, the invention provides a method of containing an underwater oil discharge, comprising: disposing a containment product comprising an oil impermeable, water-permeable material, to thereby enclose the underwater oil discharge; such as, e.g., inventive methods wherein the containment product is essentially without a base or floor, and the method includes lowering the containment product from a starting point above the underwater oil discharge until the containment product and a sea floor in a vicinity of the oil discharge form a closed shape and define a contained volume; inventive methods including containing an active oil discharge at sea floor; inventive methods including a step performed relative to an underwater oil discharge and selected from the group consisting of: doming over; tenting over; forming a bubble and forming a silo over; inventive methods further comprising evacuating oily water or oily product from the contained volume via a port in the containment product; inventive methods including lowering the containment product from a sea surface downwards towards the underwater oil discharge; inventive methods wherein the containment product comprises a weighted skirt and the disposing includes the containment product traveling from a sea surface downwards towards the underwater oil discharge; inventive methods including an assembling step before the disposing step, wherein the assembling step is performed at a sea surface or in shallow water; inventive methods including an assembling step performed in shallow water followed by transporting the containment product to be used in the disposing step towards the underwater oil discharge; and other inventive methods.

In another preferred embodiment, the invention provides a method of containing an underwater oil discharge, comprising: lowering a container that consists substantially of an oil-impermeable material (such as, e.g., an oil impermeable flexible material) into place to form a containment volume, thereby containing oil, such as, e.g., inventive methods wherein the lowering step comprises doming-over, tenting-over, bubbling-over or bagging-over the underwater oil discharge; inventive methods including performing the lowering step and containing a deepwater oil discharge in which failed or damaged equipment is involved, without performing direct work on the equipment; and other inventive methods.

The invention in another preferred embodiment provides a containment product for an underwater oil discharge (such as, e.g., a deepwater oil discharge), comprising: i) an oil-impermeable material formed into a shape; ii) at least one mass attached to the shape; such as, e.g., inventive containment products further comprising at least one buoy or bladder system; inventive containment products including at least one detachable buoy; inventive containment products wherein the shape defined by the oil-impermeable material is substantially water permeable; inventive containment products further comprising at least one attachment for a positioning cable that moves the containment product in a plane parallel to a sea floor; inventive containment products further comprising at least one port, shaped to receive a pipe or tubing through which travels oily water or oily product; and other inventive oil containment products.

In another preferred embodiment, the invention provides an open-ended oil containment structure useable to contain an underwater oil discharge at a sea floor, comprising: an oil-impermeable container section; an open bottom end, wherein when the containment structure contacts the sea floor, a containment volume is formed; such as, e.g., inventive containment structures further comprising at least one hollow section (such as, e.g., a hollow shaft; a hollow skirt; etc.) into which may be received weighting pellets or other masses; inventive oil containment structures comprising weighting pellets or other masses; inventive oil containment structures comprising at least one port that is connectible to tubing or piping through which oily water exits from the containment volume and/or connectible to an underwater oil containment bag that receives oily water exiting from the oil containment volume; inventive oil containment structures comprising a plurality of ports; inventive oil containment structures wherein the oil-impermeable container section is water permeable; inventive oil containment structures wherein the oil-impermeable container section includes a top part that is water permeable; inventive oil containment structures wherein the oil-impermeable container section comprises a water-permeable uncoated nylon material; inventive oil containment structures wherein the container section is sized and shaped that the containment volume when the containment structure contacts the sea floor is at least a million gallons; and other inventive containment structures.

Another preferred embodiment of the invention provides a method of containing an underwater oil discharge (such as a deepwater oil discharge) in which damaged or failed equipment is involved, comprising: constructing a containment volume in a vicinity of the equipment, thereby containing the oil discharge without needing to perform any direct work on the equipment.

The invention in another preferred embodiment provides an oil containment structure useable in deepwater in cooperation with a sea floor, wherein the oil containment structure when in contact with the sea floor has a containment volume of over a million gallons.

In another preferred embodiment the invention provides for a method of containing an an underwater (such as, e.g., a deepwater) oil discharge that is at or near a sea floor, comprising: using the sea floor as a wall in conjunction with an open-ended flexible, relatively light-weight structure to form an oil containment volume (such as, e.g., an oil containment volume of at least a million gallons, an oil containment volume of at least 10 million gallons, etc.).

The invention in another preferred embodiment provides an oil containment tent product, wherein the tent product, in a deployed condition, contains a quantity of oil being discharged at high-pressure occurring at an underwater location (x, y, z) where (x, y) are longitude and latitude coordinates that are at-sea and “z” represents a vertical distance which is at, or within a relatively short distance above, a seabed, such as, e.g., tent products comprising an open-based containment structure; tent products that are stored off-the-shelf and in advance of the high-pressure oil discharge emergency at the underwater location; tent products that are transportable from a storage location to a sea surface location (x, y) above the location (x, y, z) within less than 24 hours after an onset of the (x, y, z) oil discharge problem; tent products that are deployable from a storage location to the underwater location (x, y, z) within 48 hours of an onset of the (x, y, z) oil discharge problem; tent products including a material which is water-permeable and oil-impermeable; tent products including at least one hollow section into which may be received weighting pellets or other masses; tent products comprising at least one port that is connectible to tubing or piping through which oily water exits and/or connectible to an underwater oil containment bag that receives oily water; tent products wherein in use the product contains a containment volume of oil of at least a million gallons; and other tent products.

In another preferred embodiment, the invention provides a method of containing an underwater, high-pressure oil discharge at a location (x, y, z) where (x, y) are longitude and latitude coordinates that are at-sea and “z” represents a vertical distance which is at, or within a relatively short distance above, a seabed, comprising: tenting-over the high-pressure oil discharge at the location (x, y, z) (such as, e.g., a tenting-over step that comprises positioning a tent product comprising an oil impermeable, water-permeable material, the material being kept beyond and outside of a zone near the high-pressure discharge in which the oil would exert pressure on the material in a range too high for the material).

The invention in another preferred embodiment provides a method of containing an underwater oil spill near a seabed and involving a failed manmade structure (such as a failed structure from which the oil is exiting), comprising: containing a volume exterior to the failed structure, wherein the containing is performed by a tent product, without the tent product touching the failed structure.

The invention in another preferred embodiment provides an underwater oil containment kit to be used for containing oil discharge at an underwater location (x, y, z), the kit being selected from the group consisting of: a) a kit wherein no component in pre-deployment, storage form is singly too heavy to be transported by helicopter to a sea surface (x, y) above the underwater location (x, y, z); b) a kit comprising a tent product; and weighting pellets insertible into the tent product, the weighting pellets being separable into loads for transportation from storage to (x, y) or (x, y, z); c) an at-the-ready kit that when deployed at a seabed oil emergency (x, y, z) that involves a piece of failed equipment from which oil is escaping, contains the escaping oil without a responder who deployed the kit having needed to know particulars of what was wrong with the piece of equipment other than the (x, y, z) coordinates; d) a kit in which when the (x, y, z) location is a deepwater location is in place at the (x, y, z) location and containing oil same-day as a start of the seabed oil emergency; e) a kit in which when the location (x, y, z) is a deepwater location with an oil discharge emergency, the kit when deployed and assembled contains the oil at the underwater location (x, y, z), and whereas for variables characterizing the emergency, the kit is useable regardless of a value of the variables; f) a kit useable to contain the oil at the underwater location (x, y, z) regardless of values of variables characterizing the emergency, wherein the variables are selected from the group consisting of: water depth “z”; from where oil is escaping; rate at which oil is escaping; maximum pressure of escaping oil; size of opening from which oil is escaping; shape of opening from which oil is escaping; g) a rapid-response kit deployable by a responder to a set of coordinates (x, y, z) of a seabed oil emergency, wherein the set of coordinates (x, y, z) of the seabed oil emergency is sufficient for the responder deploying the kit to contain the escaping without the responder having needed to lose time to investigate: type of failed equipment; oil mixture; location of failure in equipment; and/or rate at which oil is escaping; h) a kit useable for performing a method of containing an underwater oil spill near a seabed and involving a failed manmade structure, wherein the method comprises containing a volume exterior to the failed structure, wherein the containing is performed by a tent product, without the tent product touching the failed structure; and i) a kit consisting of a set of components, each component being packaged so as to float when delivered to a sea surface location (x,y).

In another preferred embodiment, the invention provides a deepwater oil containment device, comprising a collapsible structure.

The invention, in another preferred embodiment, provides a collapsible high-volume oil containment device without an integral floor, comprising: a top frame that forms a perimeter shape and has a hollow interior; a bottom frame that forms a perimeter shape and has a hollow interior; a high surface area part that is oil-containing, is attached to the top frame and defines a top surface; and a high surface area part that is oil-containing, is attached to the bottom frame and the top frame and defines a continuous sidewall surface; wherein the device is collapsible and a most-collapsed state that is relatively flat and a most-open state that is a multi-story flexible structure, such as, e.g., inventive devices in which the top frame is a first circular ring and the bottom frame is a second circular ring (such as e.g., circular rings wherein the first circular ring and the second circular ring are of about a same circumference; circular rings wherein the first circular ring and the second circular ring are of different circumferences); inventive devices wherein the top frame and the bottom frame difference in circumference or width from each other; inventive devices wherein the top surface is a bonnet; inventive devices comprising a plurality of weights and/or a plurality of buoyancy devices, detachably attached to the top frame and/or the bottom frames; inventive devices wherein in the most-open state, the device at a smallest height dimension and at a smallest width dimension clears, by at least dozens of feet, a deepwater seabed structure that has failed or could fail; and other inventive devices.

In another preferred embodiment, the invention provides a method of mitigating a deepwater oil emergency in progress at coordinates (x, y, z), comprising: transporting, to a longitude and latitude which are about (x,y), a collapsible structure having a most-collapsed state and a most-open state; and deploying the transported collapsible structure in a vicinity of coordinates (x,y,z) in the most-open state, such as, e.g., inventive methods including including containing oily water in a vicinity of (x,y,z) and preventing oil from (x,y,z) from moving further upwards towards a sea surface; inventive methods including offloading oily water via at least one pipe attached to a surface of the structure and/or inserted under a bottom edge of the structure (such as, e.g., an offloading step that includes simultaneously offloading oily water via multiple pipes; etc.); inventive methods wherein, in the deploying step, the structure is kept clear, by at least dozens of feet, of a highest-pressure or highest-velocity point of oil movement; and other inventive methods.

In another preferred embodiment, the invention provides a filtration method, comprising: at an underwater location in a vicinity of an oil emergency, blocking molecules or particles which are larger than methane and water from traveling upwards, wherein the blocking is performed by a filter structure (such as, e.g., a filter structure that is blanket-shaped; etc.); meanwhile, receiving methane molecules into the filter structure, wherein the filter structure comprises an exit pathway through which methane molecules travel before exiting from the filter structure, such as, e.g., inventive filtration methods that comprise performing the blocking and receiving steps in deepwater; inventive filtration methods that comprise blocking at a depth of at least 1,000 feet below sea surface a quantity of hydrocarbons comprising at least barrels of oil; inventive filtration methods wherein the blocking step comprises arraying the filter structure relatively perpendicular to an upwards-moving oil flow; inventive filtration methods that comprise arraying the filter structure in deepwater; inventive filtration methods wherein the blocking step comprises arraying the filter structure relatively perpendicular to an oil flow that is moving upwards away from a source; inventive filtration methods that comprise arraying the filter structure in a path of an oil flow that is emerging from a source but without having the filter structure touch the source (such as, e.g., an arraying step wherein the arraying of the filter structure is performed without bringing the filter structure within 10 yards of the source of the oil flow; an arraying step wherein the arraying of the filter structure is performed without bringing the filter structure within 50 yards of the source of the oil flow; etc.); inventive filtration methods that comprise, while the filter structure is performing the blocking step, positioning the filter structure as to longitude, latitude and/or depth, wherein the positioning is performed by underwater remotely operated equipment; inventive filtration methods that comprise ballasting the filter structure; inventive filtration methods that comprise simultaneously disposing multiple filter structures; and other inventive filtration methods.

The invention in another preferred embodiment provides a method of blocking oil in an underwater leak from reaching the sea surface, comprising: at an underwater location in a vicinity of the underwater leak, blocking oil molecules from surface-ward travel, wherein the blocking is performed by a containment structure that consists of a ceiling and a set of sidewalls, wherein each sidewall in the set of sidewalls is non-integral with the ceiling.

In another preferred embodiment, the invention provides an emergency-response underwater oil container, comprising: a ceiling (preferably a ceiling that is methane-permeable); and at least one sidewall, wherein the sidewall is non-integral with the ceiling.

### BRIEF DESCRIPTION OF FIGURES

The invention may be appreciated with reference to the following figures, without the invention being limited thereto. Figures are not drawn to scale.

FIG. 1 is a top view of an inventive oil containment structure deployable for underwater use to an underwater oil discharge site (not shown).

FIG. 2 is a cross-sectional view corresponding to FIG. 1.

FIG. 3 is a cross-sectional view of the inventive oil containment structure 10 of FIG. 1 after having been deployed to the underwater oil discharge site.

FIG. 4 is a cross-sectional view showing use of an inventive port 4 as shown in FIG. 3.

FIG. 5 is a cross-sectional view, in close-up, showing an alternative use to that of FIG. 4 of an inventive port 4, namely use of an inventive port 4 in which oily product is off-loaded to a containment bag 50.

FIG. 6 is a representational perspective view of pertinent dimensions when containing unwanted oil discharge 100 in a vicinity of sea floor 101 according to the invention.

FIG. 7 is a perspective view of an exemplary inventive embodiment comprising a dome-shaped containment shape and a skirt.

FIG. 8 is a perspective view of an exemplary inventive embodiment comprising a cylindrical shaped containment shape and hollow shafts capable of receiving weighting pellets.

FIG. 9 is a perspective view of an exemplary inventive collapsible device 9 in an open state.

FIG. 10 depicts the device 9 of FIG. 9 in a collapsed state.

FIG. 11 is a cross-sectional view showing an inventive filtration method in an exemplary embodiment.

FIG. 12 is a perspective view showing an inventive method in an exemplary embodiment, in which sidewall 1201 is used.

### DETAILED DESCRIPTION OF A PREFERRED EMBODIMENT

Referring to FIG. 6, the invention provides for containing, in a certain underwater containment volume, an unwanted oil discharge 100 that occurs in a vicinity of sea floor 101. Oil discharge 100 in one example is emerging from destroyed or broken equipment 102 on sea floor 101. Oil discharge 100 is occurring at a location (x, y, z) where (x, y) are longitude and latitude coordinates and “z” is at or relatively near sea floor 101, with a preferred example of an underwater location (x, y, z) being where a high-pressure, deepwater oil discharge emergency is occurring. Equipment 102 has a maximum width or diameter d in a plane parallel to sea floor 101. Equipment 102 has a maximum height h above the sea floor 101. The shape shown for equipment 102 is representational, and equipment 102 may have any shape including an irregular shape. The invention also is directed to the case without equipment 102 (i.e., d=0, h=0), where oil discharge 100 emerges directly from sea floor 101.

In the invention, advantageously molecules of oil which are liquid or solid from the oil discharge 100 are stopped near (such as on the order of yards, or dozens of yards, away from) the oil discharge 100 which is near sea floor 101 rather than being permitted to follow their otherwise natural trajectory of traveling upwards to the sea surface where they would otherwise undesirably spread out and occupy a vast surface area. The stopping of the oil molecules is performed using a filtration-type approach, such as, e.g., use of a water permeable, oil impermeable physically robust membrane or other material. The membrane or other material, while selected to be relatively physically robust, would not be expected to withstand the high-pressure if put in immediate contact, or too close to where, the oil is first spewing into the water, and therefore should be kept at a sufficient distance from where the oil is first spewing into the water that the oil molecules have had an opportunity to disperse across a larger volume and are not exerting too high a pressure. That is, a tent structure should be constructed in a size big enough, and a shape such that any face of the tent structure that is to block oil molecules will not be too close to the origin of the high-pressure oil stream. That is, the inventive tent structure is constructed so that it will not touch, or even be snugly near, a failed manmade structure or equipment. Considering the size of manmade structures and structures that are candidates for failure and having high-pressure oil emerge therefrom, preferably an inventive tent structure is of a multi-story size, such as, e.g., a tall cylindrical shape that leaves substantial headroom above the top of a structure that could fail.

For providing a base of an underwater containment volume, a dimension d1 (FIG. 6) is used, d1 being substantially greater than d, and d1 being such that a circle of diameter d1 or a square of sides d1 will clear equipment 102.

For a height of an underwater containment volume, a dimension hi (FIG. 6) is used, h1 being substantially taller than h.

An inventive containment product is constructed, wherein the inventive containment product is sized and shaped to cooperate with sea floor 101 to form an underwater containment volume around equipment 102 and oil discharge 100. The inventive containment product preferably is constructed generally along the lines of what on land might be called an air-supported dome (e.g., a Yeadon air-supported dome) or a tent. The inventive containment product preferably has a collapsed form, before being put into use. The inventive containment product in its expanded form in underwater use provides a large containment volume around oil discharge 100 and equipment 102.

Examples of an open bottom of an inventive containment product are, e.g., a circular open bottom of diameter d1; a square open bottom with sides d1; etc.

Examples of a containment shape (in usage at sea floor 101) are, e.g., a silo having height h1; a cylinder having height 1; a tent having sides of height h1; a pyramid having height h1; a dome having height h1; a rain hat shape having height h1; a composite shape having height at least h1; an irregular shape having height at least h1; etc.

The containment shape used for the inventive containment product consists of an oil impermeable material. Preferably the containment shape used for the inventive containment product comprises a water-permeable, oil-impermeable material, such as, e.g., a water-permeable, oil-impermeable uncoated nylon material; etc.

By “oil impermeable”, what is meant herein is that through which the solid and liquid components of oil do not pass in substantial quantity. The passage of methane (CH₄) molecules through a material is not considered to disqualify material from being “oil impermeable”. The passage of a small number of occasional molecules of other components of oil, as may happen through seepage in above-ground oil storage, is not considered to disqualify a material from being “oil impermeable”.

An example of a water-permeable, oil-impermeable material is, e.g., a material having openings or pores slightly larger than the size of water molecules but without larger openings or pores. A water-permeable, oil-impermeable material that is physically robust is preferred. Water-penneable, oil-impermeable materials that are physically robust are commercially available, e.g., from Synder Filtration and Granite Environmental. Optionally a water-permeable, oil-impermeable material that is too weak for use singly may layered with, or sandwiched between, one or more layers of water-permeable material.

Preferably an underwater containment volume is, e.g., millions of gallons, or more.

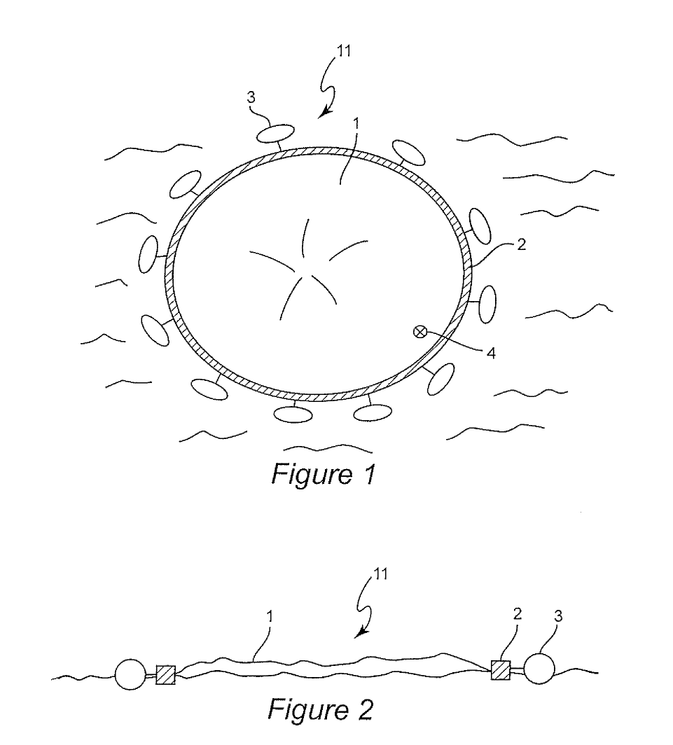

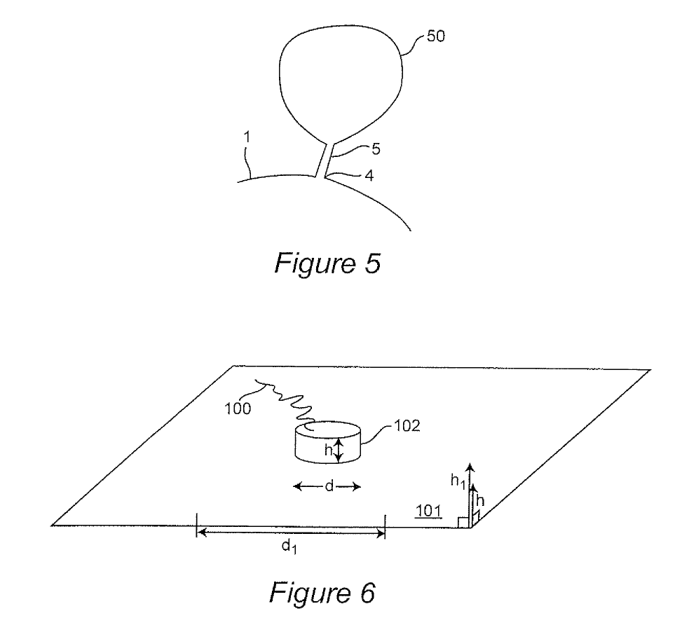

Preferably an inventive containment product includes at least one port for evacuating oily water, such as port 4 (FIG. 1). Most preferably a plurality of ports for evacuating oily water are included. Evacuation of oily water away from the oil discharge 100 and the containment volume may be, e.g., by pumping out through the port; by opening the port onto an exit channel through which oily water may travel into a containment bag such as bag 50 (FIG. 5); etc.

Advantageously, a relatively light-weight inventive flexible structure (such as, e.g., a large-volume oil containment bubble, dome, tent, silo, etc., preferably a flexible structure comprising an oil-impermeable, water-permeable material such as uncoated nylon) is arrayed at sea surface, and dispatched progressively downwards to deepwater such as by adding weighting pellets in at least one hollow region (such as, e.g., a hollow shaft, a hollow skirt, etc.) of the flexible structure. When a “tent” is mentioned herein, that means and includes a variety of shapes inclusive of bubble, silo, etc.

An inventive containment product preferably includes hook-ups for cable attachments for horizontally positioning the product, especially horizontal positioning during downwards travel of the product towards oil discharge 100. In one embodiment, the arraying of the flexible structure at sea surface may be performed in shallow water followed by pulling the array out to sea over oil discharge 100, followed by causing the flexible structure to descend downwards to deep water. In another embodiment, the arraying of the flexible structure at sea surface may be performed at sea relatively near to coordinates of oil discharge 100, followed by causing the flexible structure to descend downwards to deep water.

Advantageously, inventive oil containment products and methods may be “off-the-shelf” and useable relatively quickly in a variety of oil discharge 100 contexts, including those in deepwater, and regardless of, for example, exactly where in an existing product a failure may have happened.

Also advantageously, inventive oil containment products and methods are useable in a training context in advance of an emergency.

Further, advantageously when using the invention, performance of work (such as by underwater robotic vehicles) at areas of extremely high pressure right at oil discharge 100 and broken equipment 102 can be avoided.

Advantageously the invention may be practiced in some embodiments in the form of various kits, such as, e.g., an underwater oil containment kit useable for containing oil discharge at an underwater location (x, y, z), wherein no component in pre-deployment form is singly too heavy to be transported by helicopter to a sea surface (x, y) above the underwater location (x, y, z) (such as, e.g., an inventive kit comprising a tent product component; and weighting pellets insertible into the tent product, the weighting pellets being separable into loads each load being a component for transportation from storage to (x, y) or (x, y, z)); an at-the-ready deepwater oil containment response kit for a deepwater oil discharge emergency at an underwater location (x, y, z), wherein the kit when deployed and assembled contains the oil at the underwater location (x, y, z), and whereas for a set of variables characterizing the emergency, the kit is useable regardless of a value of the variables (such as, e.g., wherein the variables characterizing the emergency comprise: water depth “z”; from where oil is escaping; rate at which oil is escaping; maximum pressure of escaping oil; size of opening from which oil is escaping; shape of opening from which oil is escaping) (such as, e.g., an at-the-ready kit that when deployed at a seabed oil emergency (x, y, z) that involves a piece of failed equipment from which oil is escaping, contains the escaping oil without a responder who deployed the kit having needed to know particulars of what was wrong with the piece of equipment other than the (x, y, z) coordinates; a kit which is in place at the (x, y, z) location and containing oil same-day as a start of the seabed oil discharge); a rapid-response kit deployable by a responder to a set of coordinates (x, y, z) of a seabed oil emergency, wherein the set of coordinates (x, y, z) of the seabed oil emergency is sufficient for the responder deploying the kit to contain the escaping without the responder having needed to lose time to investigate: type of failed equipment; oil mixture; location of failure in equipment; and/or rate at which oil is escaping; etc.

The invention may be appreciated with reference to the following examples, without the invention being limited thereto.

### COMPARATIVE EXAMPLE 1

### Response to the BP Deepwater Horizon Incident

In January 2011, the National Commission on the BP Deepwater Horizon Oil Spill issued a Final Report (“Commission Report”). According to the Commission Report, when the oil rig (which had been on the surface) sank, a riser had broken off and was leaking; also there was a second leak from a kink in the riser, above the blowout preventer (“BOP”) atop the Macondo well. According to the Commission Report (page 132): “As BP realized that the early efforts to stop the flow of oil had failed, it considered ways to control the well other than by triggering the BOP. A primary option was to drill a relief well to intersect the Macondo well at its source and enable a drilling rig to pump in cement to stop the flow of oil. While it could take more than three months to drill, a relief well was the only source-control option mentioned by name in BP's Initial Exploration Plan. Industry and government experts characterized a relief well as the only likely and accepted solution to a subsea blowout. BP had begun looking for available drilling rigs on the morning of April 21; it secured two, and began drilling a primary relief well on May 2 and back-up well insisted upon by Secretary Salazar on May 17.”

As the Commission Report (page 132) described, “Responders, meanwhile, shifted their focus to the release of large amounts of oil. Although the National Contingency Plan requires the Coast Guard to supervise an oil-spill response in coastal waters, it does not envision that the Coast Guard will provide all, or even most, of the response equipment. That role is filled by private oil-spill removal organizations, which contract with the oil companies that are required to demonstrate response capacity. BP's main oil-spill removal organization in the Gulf is the Marine Spill Response Corporation, a nonprofit created by industry after the Exxon Valdez disaster to respond to oil spills. The Marine Spill Response Corporation dispatched four skimmers within hours of the explosion . . . . ”

According to the Commission Report (pages 132-3), “the oil-spill removal organizations were quickly outmatched” and “the technologies used in response to the Deepwater Horizon and Exxon Valdez oil spills were largely the same”. The Exxon Valdez was a ship accident and 21 years earlier.

As the Commission Report (page 135) summarized, “Though willing to fund and carry out the response, BP had no available, tested technique to stop a deepwater blowout other than the lengthy process of drilling a relief well. Forty years earlier, the government had recognized the need for subsea containment technology. In 1969, following the Santa Barbara Channel spill, the Nixon administration had issued a report recommending, in part, that ‘[u]nderwater methods to collect oil from subsea leaks should be developed.’ For deepwater wells, however, such development had never occurred. Within a week of the explosion, BP embarked on what would become a massive effort to generate containment options, either by adapting shallow-water technology to the deepwater environment, or by designing entirely new devices. Different teams at BP's Houston headquarters focused on different ways either to stop the flow of oil or to collect it at the source. Each team had what amounted to a blank check.”

BP engineers, according to the Commission Report (page 145), “[w]ithin days of discovering the leaks from the broken riser on the sea floor, . . . began to consider use of a large containment dome. The idea was to place the dome, also known as a cofferdam, over the larger of the two leaks with a pipe at the top channeling oil and gas to the Discoverer Enterprise, a ship on the surface. BP already had several cofferdams, which it had used to provide safe working space for divers repairing leaks from shallow-water wells following hurricanes Katrina and Rita. By May 4, BP had finished modifying for deep-sea use and oil collection a preexisting dome that was 14 feet wide, 24 feet long, and 40 feet tall. Following an MMS inspection of the Discoverer Enterprise, BP began to lower the 98-ton dome to the sea floor late in the evening of May 6.”

“The likelihood of collecting oil with the cofferdam was uncertain. [BP] publicly cautioned that previous successful uses had been in much shallower water. BP recognized that chief among potential problems was the risk that methane gas escaping from the well would come into contact with cold sea water and form slushy hydrates, essentially clogging the cofferdam with hydrocarbon ice.” (Commission Report, page 145).

“The effort did fail, for that reason. Although BP had a plan to deal with hydrates once the cofferdam was in place, it had not planned to mitigate hydrate formation during installation. When crews started to maneuver the cofferdam into position on the evening of May 7, hydrates formed before they could place the dome over the leak, clogging the opening through which oil was to be funneled. According to Richard Lynch, a vice president overseeing the effort, BP never anticipated hydrates developing this early.” (Commission Report, pages 145-6.)

“Because hydrocarbons are lighter than water, the containment dome became buoyant as it filled with oil and gas while BP tried to lower it. BP engineers told Lynch that they had ‘lost the cofferdam’ as the dome, full of flammable material, floated up towards the ships on the ocean surface. Averting a potential disaster, the engineers were able to regain control of the dome and move it to safety on the sea floor.” (Commission Report, page 146)

According to the Commission Report, BP's “decision to deploy the dome instead of another containment device appears to have turned more on timing than on perceived effectiveness: the dome was largely off-the-shelf and therefore ready to use in early May, before other equipment.” (Commission Report, page 146)

BP, “a little over a week after giving up on the cofferdam, on May 16, . . . was able to deploy a new collection device. Named the Riser Insertion Tube Tool, the device was a tube, four inches in diameter, that fit into the end of the riser and carried oil and gas up to the Discoverer Enterprise. This tool, BP's first effective means of containment, collected approximately 22,000 barrels of oil over its nine days of use.” (Commission Report, page 146)

Next, “BP moved towards its first attempt to kill the well completely, via procedures called the ‘top kill’ and ‘junk shot.’ . . . both procedures are standard industry techniques for stopping the flow from a blown-out well (though they had never been used in deepwater). A top kill—also known as a momentum or dynamic kill—involves pumping heavy drilling mud into the top of the well through the BOP's choke and kill lines, at rates and pressures high enough to force escaping oil back down the well and into the reservoir. A junk shot complements a top kill. It involves pumping material (including pieces of tire rubber and golf balls) into the bottom of a BOP through the choke and kill lines. That material ideally gets caught on obstructions within the BOP and impedes the flow of oil and gas. By slowing or stopping the flow, a successful junk shot makes it easier to execute a top kill.” (Commission Report, page 149)

“└T┘he top kill began on the afternoon of May 26. . . . After the third unsuccessful attempt, BP and the government agreed to discontinue the strategy.” (Commission. Report, page 150)

“BP had previously said that, if the top kill failed, its next step might be to install a second BOP on top of the existing one to shut in the well. But now, the company engineers viewed the possibility that the rupture disks had collapsed as a reason to discard capping the well as an option. If BP shut the well in, oil and gas could flow out the rupture disks and into the rock surrounding the well in a ‘broach’ or ‘underground blowout.’ From there, the hydrocarbons could rise through the layers of rock and flow into the ocean from many points on the sea floor. This would make containment nearly impossible, at least until the completion of a relief well. Thus, in the aftermath of the top kill, BP and the government focused on trying to collect the oil, with the relief wells still providing the most likely avenue for killing the well altogether.” (Commission Report, page 158)

“On May 29, the company and the government announced that BP would attempt to cut off the portion of the riser still attached to the top of the BOP and install a collection device—the ‘top hat’—which would then be connected via a new riser to the Discoverer Enterprise above. BP began installing the device on June 1, and had the top hat in place and functioning by 11:30 p.m. on June 3. Having learned from its cofferdam experience, BP injected methanol to prevent formation of hydrates. By June 8, the Discoverer Enterprise was collecting nearly 15,000 barrels of oil per day.” (Commission Report, page 159)

“BP also developed a system to bring oil and gas to the surface through the choke line on the BOP: BP outfitted the Q4000, a vessel involved in the top-kill effort, with collection equipment, including an oil and gas burner imported from France. After it became operational on June 16, the Q4000 system was able to process and burn up to 10,000 barrels of oil per day.” (Commission Report, page 159)

“By late June, BP was well on its way toward deploying a ‘capping stack,’ which, once installed on top of the BOP, would enable BP to shut in the well. The capping stack was essentially a smaller version of a BOP, similarly designed to stop the flow of oil and gas.” (Commission Report, page 162) “On July 9, as analysis of . . . risks continued, Admiral Allen authorized BP to install the capping stack, but not to close it. The extremely complicated operation began the next day. After removing the top hat from the top of the riser, remotely operated vehicles had to unbolt the stub of riser connected to the top of the Deepwater Horizon BOP stack, remove this stub, look for any pieces of drill pipe sticking up through the top of the BOP stack, slide the capping stack into place, and bolt it to the BOP stack. The process went smoothly, and BP finished installing the capping stack without incident by July 12.” (Commission Report, page 164)

“BP shut the stack and began the well integrity test at about 2:25 p.m. on July 15. For the first time in 87 days, no oil flowed into the Gulf of Mexico.” (Commission Report, page 165)

“In mid-September, the first relief well—which BP had begun drilling in early May—finally intercepted the Macondo well, allowing BP to pump in cement and permanently seal the reservoir. On Sep. 19, 152 days after the blowout, Admiral Allen announced: ‘the Macondo 252 well is effectively dead.” (Commission Report, page 169)

### EXAMPLE 1

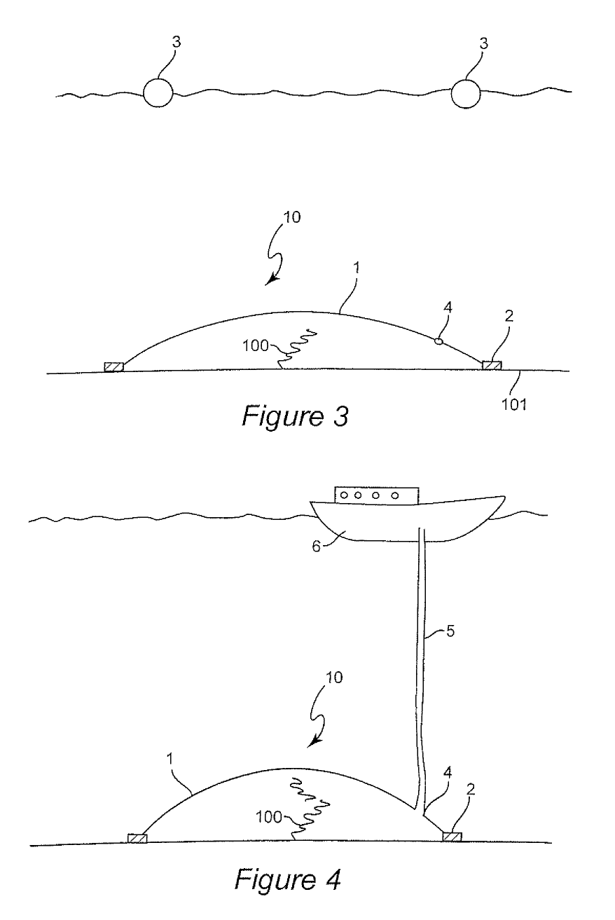

In this inventive example, referring first to FIGS. 1 and 2, system 11 comprises an oil containment structure 10 (FIG. 3) deployable for underwater use to an underwater oil discharge site (such as, e.g., oil discharge 100 (FIG. 6)), and consists essentially of an oil impermeable material 1, a weighted perimeter region 2, and a buoyant counter-balancing system 3. The system 11 (FIG. 1) is the containment structure 10 (FIG. 3) plus the buoyant counter-balancing system 3.

The oil impermeable material 1 most preferably is also water-permeable.

Shape-wise, the oil impermeable material 1 preferably is non-planar and in underwater use assumes a three-dimensional shape, e.g., a bag, a bubble, a dome, a tent, a silo, etc. In FIG. 1, the oil impermeable material 1 is shown as having a circular perimeter but the invention is not limited to embodiments with circular perimeters.

The weighted perimeter region 2 preferably is integral with the oil impermeable material 1. Weighted perimeter region 2 has a total mass sufficient to hold the oil impermeable material 1 in relatively static position over an underwater oil discharge site (such as oil discharge 100 in FIG. 6).

Buoyant counter-balancing system 3 is illustrated in FIG. 1 as a set of detachable buoys that counter-balance weighted perimeter 2 when at a surface of a body of water, but counter-balancing system 3 is not limited to a set of detachable buoys and other buoyancy measures may be used, such as, e.g., deflating air bladders, etc., which may be detachable from or integral with the weighted perimeter region 2. Also, counter-balancing system 3 is not limited to a position as shown in FIG. 1, but may be, for example, underneath other parts of system 11. For example, buoyant counter-balancing system 3 may comprise a series of raft-like platforms connected to each other, with the rest of the system 11 resting atop the raft-like platforms, with outer-most raft-like platforms capable of being deflated and removed (such as, e.g., by being dragged away) in order for the rest of system 11 to proceed downwards through the water, with system 11 being progressively reduced at to buoyancy.

Preferably, the oil containment structure 10 (FIG. 3) includes at least one port 4 (FIGS. 1, 3) capable of receiving a pipe or tubing, and preferably includes a plurality of ports 4.

In FIG. 3, the oil containment structure 10 is shown deployed at an underwater oil discharge 100 site. In FIG. 3, buoyant counter-balancing system 3 are illustrated as buoys that were detached from the oil containment structure 10 to permit the containment structure 10 to travel downwards through the seawater in a direction of the underwater oil discharge site. Alternately, a non-detaching buoyant counter-balancing system may be used such as, e.g., bladders. Preferably, the buoyant counter-balancing system 3 is detached in parts or otherwise controllably from the containment structure 10, and as the structure 10 travels downwards underwater, the structure 10's position is assessed and the structure 10 is moved as needed to be headed towards the oil discharge 100 site. For moving the containment structure 10 into position over the underwater oil discharge 100 site, preferably the containment structure 10 includes a series of hook-ups (not shown) for positioning cables (not shown).

Containment structure 10 when weighted perimeter 2 is in contact with a sea floor defines a volume which is an inventive containment volume. When containment structure 10 initially contacts the sea floor, the contained volume defined by the structure comprises somewhat oily water. As the oil discharge continues with the containment structure 10 in place, water molecules exit via where the material 1 is water-permeable, but oil is prevented from exiting and remains within the contained volume. As more oil is discharged and occupies the contained volume, relatively more water molecules will be expelled from, than will enter, the contained volume, and pressure management preferably is performed.

To manage the pressure as the oil content increases in the contained volume, port 4 receives pipe or tubing 5 (FIG. 4) through which is evacuated a volume of oily product from the contained volume, such as, e.g., to a controlled processing station or container 6.

### EXAMPLE 1A

In this inventive example, as shown in FIG. 5, port 4 receives pipe or tubing 5 through which travels a volume of oily product from the contained volume to a bag 50 such as, preferably, an oil impermeable, water-permeable bag.

Advantageously, a bag 50 may be used at a deepwater location, so that a plurality of bags 50 each bag 50 connected to a respective port 4 can service an underwater oil discharge 100 even when a processing station 6 on a water surface may be required to detach and travel to safety due to approaching bad weather.

### EXAMPLE 2

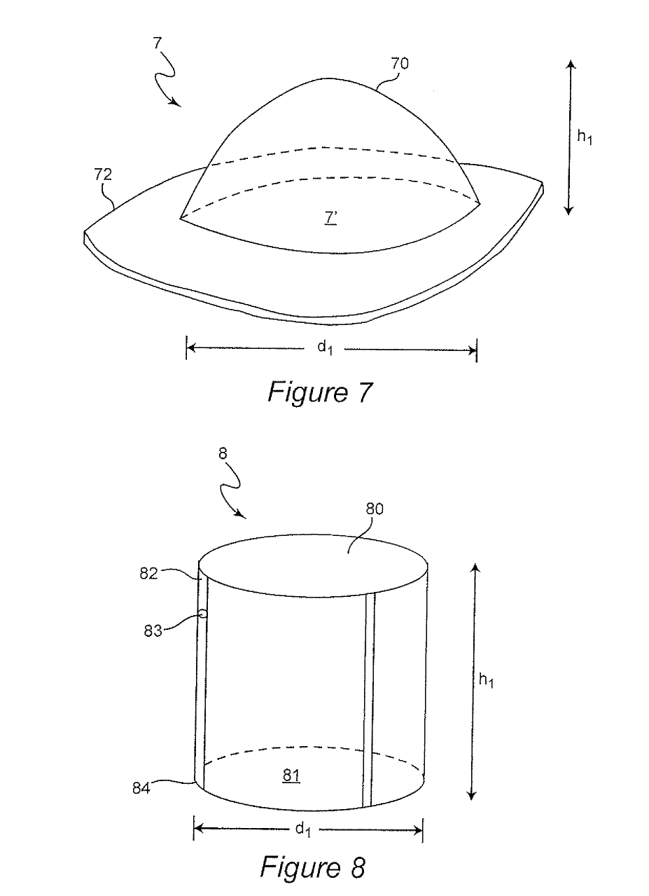

In this inventive example, referring to FIG. 7, an inventive containment product 7 comprises a containment dome 70 having a circular open bottom 71 of diameter d1 and having a height h1. Preferably dome 70 comprises an oil impermeable, water-permeable material such as an uncoated nylon material.

The inventive product 7 of this example comprises skirt 72 attached to containment dome 70. Skirt 72 preferably is hollow, and may contain air when the product 72 is on a water surface, and may receive a quantity of masses (such as, e.g., weighting pellets, etc.) to accomplish controllable lowering of the product 7 from a water surface down to a sea floor 101.

### EXAMPLE 3

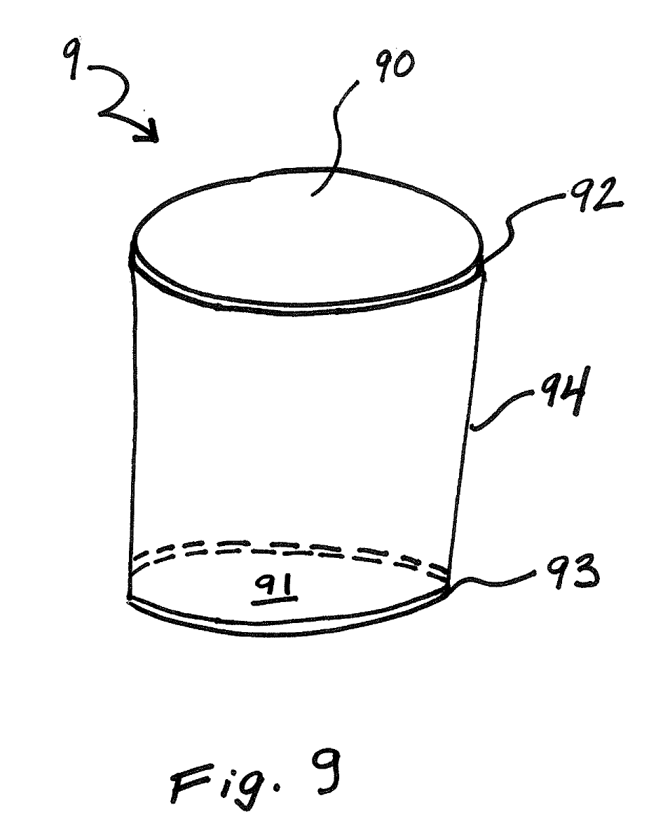

In this inventive example, referring to FIG. 8, an inventive containment product 8 is cylindrical having height h1, having a circular open bottom 81 of diameter d1, and a top 80. Preferably top 80 comprises an oil impermeable, water-permeable material such as an uncoated nylon material.

The inventive product 8 of this example comprises hollow shafts 82. Shafts 82 may extend along the height h1 of the product 8 as shown in FIG. 8, or may be shorter than height h1. The number of shafts 82 is not particularly limited and product 8 may be constructed with various numbers of shafts 82.

Shaft 82 comprises opening 83 through which masses (such as, e.g., weighting pellets) are received, to accomplish controllable lowering of the product 8 down to a sea floor 101.

Shaft bottom end 84 may be provided with a shaft floor so that weighting pellets accumulate in shaft 82. Alternately, shaft bottom end 84 may be provided with a shaft bottom opening so that weighting pellets pass into a hollow skirt (not shown) and accumulate in the skirt.

Shafts 82 and hollow skirt (if any) are provided so that the total volume of the shafts 82 and hollow skirt (if any) is sufficient to receive enough mass (such as, e.g. weighting pellets) for the product 8 to generally transport itself downwards, as weight is delivered into it, to the depth of sea water at which the product 8 is to be used for oil containment of oil discharge 100.

### EXAMPLE 4

### Collapsible Oil Containment Device

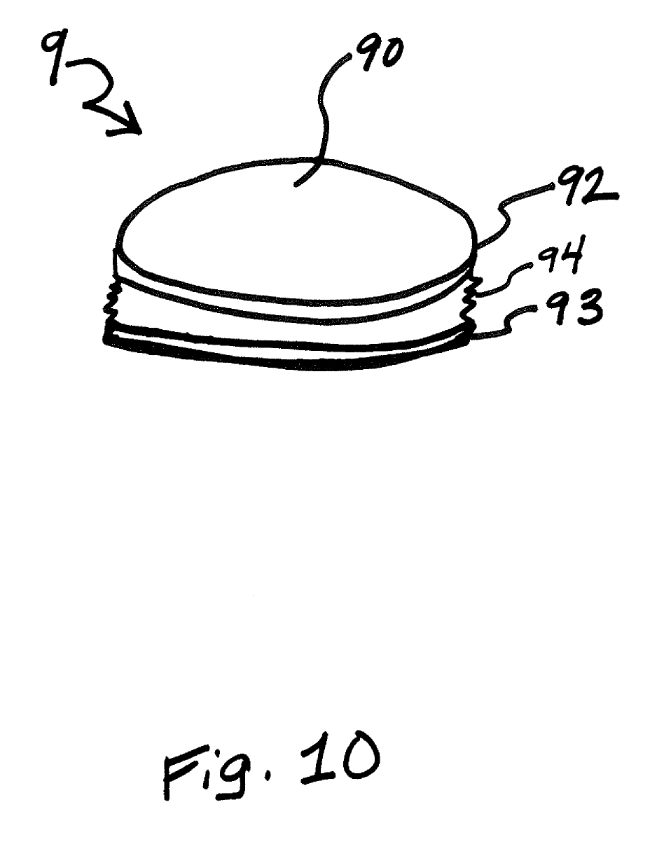

In this inventive example, referring to FIGS. 9 and 10, an inventive oil containment device 9 is collapsible. Device 9 has no integral floor and has an open bottom 91. Device 9 in its open state (FIG. 9) has a multi-story height suitable for clearing failed deepwater seabed equipment from which oil might escape, and a diameter or width dimensions suitable for clearing the mentioned failed equipment (preferably with a clearance of at least dozens of feet).

Top 90 is made of an oil-containing material. Preferably top 90 is a high surface area bonnet.

Sidewall surface 94 is made of an oil-containing material.

Device 9 comprises a top frame 92 and a bottom frame 93 which preferably are circular and are thus illustrated but may be shaped otherwise.

Top 90 is attached to top frame 92.

Sidewall surface part 94 at its top edge is attached to top frame 92 and at its bottom edge is attached to bottom frame 93.

Top frame 92 and bottom frame 93 are sturdily made for providing contact points when the device 9 is lifted, towed, pulled, etc.

Preferably top frame 92 includes attachment points (not shown) for receiving detachable devices (such as, e.g., buoyancy devices; cables; etc.). Preferably bottom frame 93 includes attachment points (not shown) for receiving detachable devices (such as, e.g., weight devices, cables; etc.).

The collapsed state (FIG. 10) is preferred for transit (such as, e.g., transit on a deck of a surface vessel, etc.) of device 9 from storage to a longitude and latitude near a deepwater oil emergency. Device 9 in its collapsed state is readily moved, such as by hoisting by tether and winch on a surface vessel to be deployed over the side of the vessel.

Preferably one or more pipes (not shown) for offloading oily water are attachable or attached to device 9 such as at respective interfaces or ports (not shown in FIGS. 9-10) on top 90, sidewall 94 and/or top frame 92.

The device 9 is maneuverable by, e.g., maneuvering by submersible ROVs; maneuvering by remotely-operated motors (not shown) attached to device 9 itself; maneuvering by guidance down a tether (not shown) deployed in advance of the device 9; etc.

During an initial phase, when the device 9 is on the surface (such as on a surface vessel), location tracking preferably is accomplished using GPS such as the surface vessel's GPS. During an intermediate deployment phase, location tracking regarding progress of the device 9 towards emergency location (x,y,z) preferably is accomplished using sonar. During a terminal phase, location tracking regarding progress of the device 9 in its open state into position preferably is accomplished using remotely-monitored underwater cameras (not shown) mounted on the device 9 (such as mounted on a skirt of the device 9).

### EXAMPLE 4A

In this inventive example, device 9 from Example 4 includes an attached pipe for offloading oily water with the pipe attached to or threaded through a port (not shown) in frame 92.

### EXAMPLE 4B

In this inventive example, the collapsible device 9 descends collapsed and sideways. A collapsed, sideways descent for device 9 reduces the chance of trapping sea life or a destructive object that might damage any exposed membrane used in the device 9.

### EXAMPLE 4C

In this inventive example, a material such as a membrane that is relatively easier to damage such as by tearing is protected by being sandwiched between other, more robust layers.

### EXAMPLE 5

In this inventive example, a failure (such as a tear) that has appeared in a membrane is over-patched, such as by applying (such as by using a staple gun or sewing gun) a patch section. The patch section may be of a same or different material as the section being repaired. For over-patching when deepwater deployment is in progress, preferably, the patch section is of a oil-containing material with strongest physical robustness.

### EXAMPLE 6

In this inventive example, in a path of a deepwater oil flow consisting of oil molecules of various sizes, is used a membrane with pores that are substantially larger than a water molecule or methane molecule and through which oil molecules on the small-size end may pass at a time of initial deployment while meanwhile the membrane, from the initial time of deployment, blocks oil molecules on a larger-size end. A “fouling” characteristic of the membrane is exploited, as the larger molecules of the oil flow, over time, block the pores so that after the thus-configured membrane has been deployed for a time at which fouling is achieved, even smaller-sized oil molecules are no longer able to pass through the membrane.

### EXAMPLE 7

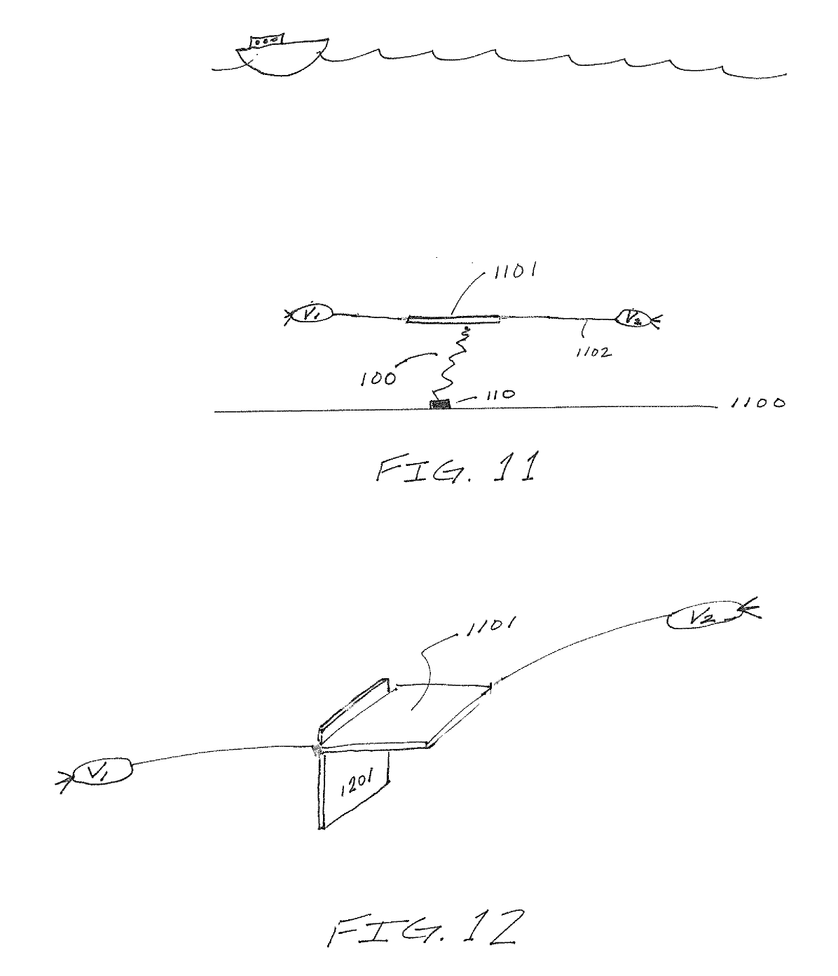

In this inventive example, and as further appreciated with reference to FIG. 11, filtration structure 1101 (such as, e.g., a blanket-shaped filtration structure, etc.) blocks oil discharge 100 which is emerging from source 110 (such as a broken riser, etc.) at sea bed 1100 (which may be, e.g., in deepwater). Filtration structure 1101 does not touch source 110.

Filtration structure 1101 is positioned, for example, by underwater equipment VI, V2 using tow lines 1102.

### EXAMPLE 7A

In this inventive example, and as further appreciated with reference to FIG. 12, an underwater container comprising non-attached parts is provided. Filtration structure 1101 is positioned as a ceiling above source 110 (not shown in FIG. 12). Sidewall 1201 is non-integral with the filtration structure 1101 which is the ceiling. Sidewall 1201 is moveable into position by different equipment other than V1, V2 that is positioning the ceiling.

Sidewall 1201 need not necessarily touch the sea floor 1100 (not shown in FIG. 12).

Additional sidewalls (not shown in FIG. 12) are added as wanted, to confine oil discharge 100.

Preferably an underwater container comprising non-attached parts is assembled so that at least one sidewall does not obstruct the source 110 so that other equipment can access the source 110 and, if wanted, source 110 can continue to be worked-on directly.

While the invention has been described in terms of a preferred embodiment, those skilled in the art will recognize that the invention can be practiced with modification within the spirit and scope of the appended claims.

What I claim as my invention is:

1. A filtration method, comprising:
at an underwater location in a vicinity of an oil emergency, blocking molecules or particles which are larger than methane and water from traveling upwards, wherein the blocking is performed by a filter structure; meanwhile,
receiving methane molecules into the filter structure, wherein the filter structure comprises an exit pathway through which methane molecules travel before exiting from the filter structure.

2. The filtration method of claim 1, comprising performing the blocking and receiving steps in deepwater.

3. The filtration method of claim 1, comprising blocking at a depth of at least 1,000 feet below sea surface a quantity of hydrocarbons comprising at least barrels of oil.

4. The filtration method of claim 1, wherein the blocking step comprises arraying the filter structure relatively perpendicular to an upwards-moving oil flow.

5. The filtration method of claim 1, comprising arraying the filter structure in deepwater.

6. The filtration method of claim 1, wherein the blocking step comprises arraying the filter structure relatively perpendicular to an oil flow that is moving upwards away from a source.

7. The filtration method of claim 1, comprising arraying the filter structure in a path of an oil flow that is emerging from a source but without having the filter structure touch the source.

8. The filtration method of claim 7, wherein the arraying of the filter structure is performed without bringing the filter structure within 10 yards of the source of the oil flow.

9. The filtration method of claim 8, wherein the arraying of the filter structure is performed without bringing the filter structure within 50 yards of the source of the oil flow.

10. The filtration method of claim 1, further comprising: while the filter structure is performing the blocking step, positioning the filter structure as to longitude, latitude and/or depth, wherein the positioning is performed by underwater remotely operated equipment.

11. The filtration method of claim 1, further comprising: ballasting the filter structure.

12. The filtration method of claim 1, wherein the filter structure is blanket-shaped.

13. The filtration method of claim 1, comprising simultaneously disposing multiple filter structures.

14. A method of blocking oil in an underwater leak from reaching the sea surface, comprising:
at an underwater location in a vicinity of the underwater leak, blocking oil molecules from surface-ward travel, wherein the blocking is performed by a containment structure that consists of a ceiling and a set of sidewalls, wherein each sidewall in the set of sidewalls is non-integral with the ceiling.

15. An emergency-response underwater oil container, comprising:
a ceiling;
at least one sidewall, wherein the sidewall is non-integral with the ceiling.

16. The emergency-response underwater oil container of claim 15, wherein the ceiling is a methane-permeable ceiling.
